(19) United States
(12) Patent Application Publication
(10) Pub. No.: US 2008/0032076 A1
(43) Pub. Date: Feb. 7, 2008

(54) Shrinkable Multilayered Film Comprising a Release Layer

(75) Inventors: Bernard Dujardin, Brussel (BE); Walter Bering, Durach (DE)

Correspondence Address: NORRIS, MCLAUGHLIN & MARCUS, P.A., 875 THIRD AVE, 18TH FLOOR, NEW YORK, NY, 10022, US

(73) Assignee: CFS KEMPTEN GMBH, Kempten (DE)

(21) Appl. No.: 11/722,869

(22) PCT Filed: Dec. 21, 2005
(86) PCT No.: PCT/EP05/57035

§ 371 Date: Jul. 2, 2007

(30) Foreign Application Priority Data
Dec. 27, 2004 (DE) 10 2004 063 619.2

(51) Int. Cl. B65D 65/40; B32B 27/32

(52) U.S. Cl. 428/34.9; 428/332; 428/411.1; 428/412; 428/474.4; 428/497; 428/523

(57) ABSTRACT

Heat-shrinkable multilayer film comprising at least one carrier layer a) based on at least one thermoplastic polymer, at least one gas barrier layer, and at least one sealing layer; the entire free surface of the carrier layer opposing the gas barrier layer being covered with an outer release layer having a plasticizing or melting temperature that is at least 30° C. higher than the sealing or melting temperature of the sealing layer.

The present invention relates to a heat-shrinkable multilayered film comprising at least one carrier layer based on at least one thermoplastic polymer having a melting point of preferably less than 170° C., at least one gas barrier layer and at least one sealing layer, that surface of the carrier layer which is remote from the gas barrier layer being entirely covered with an outer release layer having a plasticizing or melting temperature at least 30° C. higher than the sealing or melting temperature of the sealing layer, to the preparation thereof, to the use thereof as a packaging material and to corresponding packages consisting of the multilayered film according to the invention.

Heat-shrinkable multilayered films are implemented in a large number of useful applications for packaging foodstuffs. When using these films, the goods to be packaged are enclosed by the multilayered film or introduced into a sachet of such a multilayered film, the air then being removed from the interior of the package, which is subsequently exposed to a source of heat such that the multilayered film shrinks and assumes the shape of the packaged goods.

Heat-shrinkable multilayered films preferably have a gas barrier layer, in particular an oxygen barrier layer, since the penetration of oxygen leads to oxidative deterioration in the case of many goods, in particular foodstuffs. These films must additionally have a good sealing strength, in order that the packages produced with the film are stable to delamination even at elevated temperatures, such as shrinkage temperatures, and do not lose their integrity. Heat-shrinkable multilayered films should moreover have good mechanical properties in order that they can withstand the stresses during the production process and transport to the customer.

For the purpose of marketing the packaged goods to the consumer, it is, moreover, necessary for the heat-shrinkable films to have good visual properties to enhance the attractiveness of the package.

Multilayered films which meet these requirements are known in the prior art and are also commercially obtainable.

A problem in the production of packages of heat-shrinkable multilayered films in known packaging machines, for example in horizontal and vertical automatic packaging machines, in particular in sachet packaging machines, is that during the manufacture of the package, in particular of the sachet, the individual packages simultaneously lined up for sealing are often inserted into the sealing tool overlapping each other and not separately from one another, as would be necessary. This causes the outer layers of the packages superimposed on one another to be sealed together in the overlapping region. Such packaging sachets can no longer be used, and thus a large number of rejects are produced.

The prior art (WO 99/26783 and WO 00/26024) discloses that this undesirable sticking of packages together in the overlapping regions can be avoided by the use of a heat-shrinkable multilayered film having an outer layer of polyamide. This restriction of the carrier or outer layer to the use of a polyamide can also lead to restrictions in the possible uses of the multilayered film, e.g. in the production of packages, so that alternative solutions to the above problem should be looked for.

It is therefore an object of the present invention to provide a heat-shrinkable multilayered film, with which the problem of unwanted sticking of packages together in any possibly overlapping regions during the sealing operation is avoided and no restriction of the outer or carrier layer material to polyamide is necessary.

This object is achieved by providing the heat-shrinkable multilayered film according to the invention, comprising at least one carrier layer a) based on a thermoplastic polymer, a gas barrier layer b) and a sealing layer c), that surface of the carrier layer a) which is remote from the gas barrier layer b) and is directed outwardly being entirely covered with a transparent, outer release layer d), which has a plasticizing or melting temperature which is at least 30° C. higher than the sealing or melting temperature of the sealing layer c).

The carrier layer is preferably based on a thermoplastic polymer which has a melting temperature of not more than 170° C., preferably less than 170° C. and more preferably less than 160° C..

The carrier layer a) is preferably based on at least one thermoplastic polymer selected from the group consisting of polyamides, copolyamides, polyolefins, and olefin copolymers. The carrier layer a) is preferably based on an aliphatic polyamide or copolyamide, a polyethylene and more preferably polyethylene having a density>0.92 g/cm³, a polypropylene (PP), an ethylene copolymer and more preferably an ethylene/vinyl acetate copolymer and/or a propylene copolymer. A suitable aliphatic polyamide is polyamide 6 and its copolyamides. The carrier layer a) is very preferably based on a mixture of from 70 to 90% by weight of linear low-density polyethylene (LLDPE), from 10 to 30% by weight of ethylene/vinyl acetate copolymer and optionally up to 5% of customary additives, in each case based on the total weight of the carrier layer a). The use of a mixture of LLDPE and an ethylene/vinyl acetate copolymer for the production of a heat-shrinkable multilayered film is advantageous, since this thermoplastic mixture shows excellent shrinkage behavior.

Customary additives are to be understood as meaning antiblocking agents, antistatic agents, and/or lubricants.

The carrier layer a) has a thickness of preferably from 3 to 50 μm and more preferably from 3-20 μm.

The gas barrier layer b) is preferably based on at least one polymer selected from the group consisting of ethylene/vinyl alcohol copolymer, vinylidene chloride copolymer, polyester and polyamide, preferably a vinylidene chloride copolymer. The layer b) is preferably largely impermeable both to oxygen and to water vapor. This property is retained even at elevated temperatures.

The gas barrier layer b) has a thickness of preferably from 2 to 15 μm and more preferably from 3 to 10 μm.

The sealing layer c) is preferably based on at least one polymer selected from the group consisting of polyolefins and olefin copolymers. The polymers used for the preparation of the sealing layer c) are those officially permitted for the production of packages which are to be brought into contact with foodstuffs.

In a preferred embodiment, the sealing layer c) is based on a mixture of polyolefins selected from the group consisting of m-polyethylene (m-PE), high-density polyethylene (HDPE), low-density polyethylene (LDPE), linear low-density polyethylene (LLDPE), ethylene copolymer, polypropylene, and propylene copolymer.

The sealing layer c) is very preferably based on m-PE, LDPE, LLDPE, ethylene copolymer, or mixtures thereof.

The sealing layer c) has a thickness of preferably from 5 to 30 μm and more preferably from 5 to 20 μm. The melting temperature of the sealing layer c) is preferably from 90° C. to 140° C. and more preferably from 95° C. to 130° C..

The release layer d) is preferably based on a transparent natural or synthetic polymer, which is preferably thermoplastic and more preferably also extrudable or which, as a lacquer, can be applied dissolved in a suitable solvent or dispersed in a dispersant optionally together with plasticizer.

The release layer is very preferably distinguished by peelability from itself, i.e. the corresponding adhesive strength measured according to known standard methods between 2 release layers is preferably in the range of from 0.01 to 8 N/15 mm, preferably in the range of from 0.1 to 7 N/15 mm and very preferably in the range of from 0.5 to 6 N/15 mm. The adhesive strength is preferably measured as specified in DIN EN ISO 527 Instructional Pamphlet No. 33, similarly to testing the strength of hot-seal welds.

The release layer d) is preferably based on at least one natural or synthetic polymer selected from the group consisting of cellulose derivatives (with the exception of nitrocellulose), acrylic resins, epoxy resins, polyesters, preferably amorphous polyesters, ketone resins, hydrocarbon resins, polyamidimides, polyarylamides, polycarbonates, polyethersulfones, polyimides, polyolefins, polyphenylene oxides, polyurethanes, resorcinol resins, polyacrylates, vinyl chloride copolymers, urethane alkyd resins and silicone resins. These polymers should be selected such that their melting temperature is higher than the sealing or melting temperature of the sealing layer c) by at least 30° C..

If the release layer is applied as a lacquer, the solvent employed for the polymer is preferably at least one organic, preferably readily volatile, solvent selected from the group consisting of ethyl acetate, n-butyl acetate, methyl acetate, n-amyl acetate, methyl isobutyl ketone, methyl ethyl ketone, ethanol, propanol, isopropanol, n-butanol, toluene, heptane, isopropyl acetate, and hexane. In addition, the use of an aqueous dispersion medium, the solution media mentioned can also serve as dispersion media.

The lacquer that has been applied can optionally be cured by curing catalysts present therein or by radiation. The layer can contain antiblocking agents, lubricants, or stabilizers as further additives.

The release lacquer d) can contain at least one plasticizer. Suitable plasticizers are tricresyl phosphate, benzyl benzoate, tributyl phosphate, butyl acetylricinoleate, glyceryl acetylricinoleate, dibutyl phthalate, dibutyl glycolate, dioctyl phthalate, butyl stearate, triphenyl phosphate, triethyl citrate, tributyl citrate, tributylacetyl citrate, dibutyl tartrate, diisobutyl phthalate, diamyl phthalate, and camphor.

In a particularly preferred embodiment, the release layer d) is based on at least one cellulose derivative. With the exception of nitrocellulose, the cellulose derivatives employed are at least one cellulose derivative selected from the group consisting of ethylcellulose, hydroxyethylcellulose, hydroxypropylmethylcellulose, and cellulose acetate. The cellulose derivative can optionally be applied dissolved or dispersed in a solvent, optionally treated with plasticizers, or as a mixture with other plastics materials, preferably acrylic resins.

The release layer d), when freed from the solvent and based on at least one cellulose derivative, preferably contains from 70 to 95% by weight and more preferably from 80 to 90% by weight of at least one cellulose derivative and from 5 to 30% by weight, more preferably from 2 to 10% by weight and even more preferably from 5 to 7% by weight of at least one plasticizer.

In another particularly preferred embodiment, the release layer d) is based on at least one transparent silicone resin which is extrudable.

According to another preferred embodiment, the release layer d) is based on an ethylene/vinyl chloride copolymer, which can be applied, when dissolved in a solvent, as a lacquer or by extrusion. This also applies to acrylic resins. If polycarbonates or polyesters, preferably amorphous polyesters, are applied as a release layer, this preferably takes place by extrusion.

The release layer d) preferably has a plasticizing or melting temperature which is at least 30° C. and more preferably at least 160° C. higher than the sealing or melting temperature of the sealing layer c).

The release layer d) has a plasticizing or melting temperature of preferably from 175° C. to 250° C. and more preferably from 185° C. to 230° C..

The thickness of the transparent release layer d) is preferably in the range of from 0.1 μm to 10 μm and more preferably in the range of from 3 to 6 μm.

The multilayered film according to the invention can contain further layers based on at least one thermoplastic polymer selected from the group consisting of polyolefins, olefin copolymers, polyesters, and polyamides.

The multilayered film preferably contains at least one adhesion promoter layer. The adhesion promoter layer can be present between the carrier layer a) and the gas barrier layer b) and/or between the gas barrier layer b) and the sealing layer c).

The adhesion promoter layer is preferably based on a mixture of at least one polyolefin and/or olefin copolymer, which optionally contains grafted maleic anhydride units, preferably at least one polymer selected from the group consisting of LDPE, HDPE, PP, ethylene/vinyl alcohol copolymer and ethylene/vinyl acetate copolymer.

An adhesion promoter layer can have a thickness of preferably from 5 to 50 μm and more preferably from 5 to 15 μm.

The thicknesses specified are to be understood as meaning the thickness of the respective layer of the multilayered film according to the invention after longitudinal and transverse orientation has taken place.

The multilayered film according to the invention preferably comprises at least one group of successive layers consisting of a release layer d), a carrier layer a), an adhesion promoter layer, a gas barrier layer b), an adhesion promoter layer, and a sealing layer c).

Each layer of the multilayered film according to the invention can preferably contain the usual additives and auxiliaries, such as fillers, pigments, colorants, antistatics, and/or stabilizers.

The multilayered film according to the invention can be printed, and at least one layer of the multilayered film can be printed or can be dyed by the addition of additives such as organic or inorganic dyes or pigments.

The sealing layer c) can preferably be subjected to finishing treatment using the usual auxiliaries, such as antistatics, lubricants, and/or spacers.

The multilayered film according to the invention is preferably oriented longitudinally in the machine direction at a ratio of from 1:3 to 1:5 and transversely to the machine direction at a ratio of from 1:3 to 1:5. The multilayered film according to the invention is more preferably oriented longitudinally in the machine direction at a ratio of from 1:3.5 to 1:4.5 and transversely to the machine direction at a ratio of from 1:3.5 to 1:4.5.

The multilayered film according to the invention thus preferably displays shrinkability in both the longitudinal and the transverse directions of from 15 to 35% when it is heated for at least 6 seconds at a temperature of at least 85° C..

The multilayered film according to the invention is pasteurizable. Pasteurization in this context means a process for the preservation of usually liquid foodstuffs. To this end, the packaged foodstuffs are heated briefly at a temperature of not more than 100° C.. The temperature used varies according to the process used and the foodstuff involved.

The multilayered film according to the invention can be produced by a process involving blowing, the production of a flat film, or by coating, extruding, and coextruding or by the use of an appropriate coating or laminating process, the release layer d) being applied simultaneously or subsequently.

First, the multilayered film according to the invention is preferably produced by the film blowing-coextrusion process described, for example, in U.S. Pat. No. 3,456,044. However, it is also possible to initially extrude only the carrier layer a) as the outer layer as a tube and to apply the subsequent layers by coextrusion, or to extrude any desired subcombination as a tubular film and then immediately to extrude the remaining layers onto it. The application of the release layer can then take place.

The multilayered film according to the invention is preferably produced in the form of a tubular film, whose innermost layer forms the sealing layer c) and the outermost layer is the release layer d).

Before the application of the release layer d), the film can be corona-treated and/or plasma-treated by conventional processes known to the person skilled in the art, in order to achieve better adhesion. The application of the release layer d) preferably takes place in a low-pressure unit, with the aid of a Flexoprint machine, by spray coating or by reverse roll coating. The application of the release layer d) can also take place in line with the preferred coextrusion/blowing process. The application of the release layer d) to the flattened multilayered tubular film is preferably carried out by simultaneous application to the two uncovered outer sides of the tubing.

The release layer is optionally irradiated after application using UV light or electron beams. An applied lacquer d) is preferably dried by blowing air over the coated multilayered film in a drying channel at a temperature of from 20 to 40° C. and preferably at a temperature of from 25 to 30° C., and/or by applying a vacuum for the removal of the organic solvents.

If the release layer d) is based on an extrudable, thermoplastic polymer, which after its application can be oriented and is thus heat-shrinkable, the release layer can be applied to the multilayered film composite by extrusion, optionally by coextrusion.

One or all layers of the multilayered film according to the invention are preferably crosslinked before or after orientation in order to increase their penetration resistance. Crosslinking is preferably carried out by the use of β-radiation. The irradiation source used is an electron beam generator, which operates in a range of from 150 kV to 300 kV. For irradiation, a dose of 60 kGy is preferably used in order to crosslink the entire film or alternatively to crosslink only individual layers such as, for example, the carrier layer.

The polymers employed for forming the layers in the multilayered film are commercially obtainable and are adequately described in the prior art. In the production of the multilayered films according to the invention, they are customarily mixed in the form of pellets or granules, as necessary, in conventional mixers and are converted to the desired final form by melting, preferably with the aid of extruders. As already mentioned, production using the film-blowing/coextrusion process is preferred, extruders having multiple dyes being used to ensure the formation of a multilayered tube. The processing temperatures used, in particular during extrusion, are known to the person skilled in the art and are specified in general for the preparation of the plastics materials. Coating takes place using equipment suitable for the process variant used.

The multilayered films according to the invention are extremely suitable for packaging goods, preferably foodstuffs and more preferably perishable foodstuffs.

A further aspect of the present invention therefore comprises packages consisting of a heat-shrinkable multilayered film of the invention, preferably used for foodstuffs and more preferably for perishable foodstuffs.

A further aspect of the present invention comprises pasteurizable packages consisting of a tubular film of the invention in the form of sachets and the use of these packages for packaging foodstuffs, preferably perishable foodstuffs.

The packages according to the invention can be produced from the multilayered films of the invention in the packaging machines known to the person skilled in the art and filled, for example in horizontal or vertical automatic packaging machines or in sachet packaging machines.

### EXAMPLES

For the purposes of measuring the shrinkability of a film according to the invention, a 10×10 cm reticule is drawn on the film sample to be tested using a film marker, one bar being drawn in the machine direction (md), ie, the extrusion direction, while the second bar of the reticule is marked crosswise to the machine direction (cmd). The water bath in which the film sample is immersed for 6 sec has a temperature of 85° C..

After 6 sec, the sample is removed, the reduction in size of the reticule is measured and this size reduction is recorded for the respective direction as the ratio thereof to the starting length of the reticule in %.

### Example 1

A multilayered film having the following construction was produced by coextrusion/blowing processes:

A carrier layer a) of a mixture of 81% by weight of LLDPE (Stamylex® 08026-F supplied by DexPlastomers, Netherlands), 15% by weight of an ethylene/vinyl acetate copolymer containing 12 mol % of vinyl acetate units (Elvax® 3135X supplied by DuPont, USA), and 4% by weight of an antiblocking agent, this layer having a thickness of 10 μm;

an adhesion promoter layer attached to the carrier layer a) and consisting of a mixture of 30% by weight of an ethylene/vinyl acetate copolymer containing 12 mol % of vinyl acetate units (Elvax® 3135X supplied by DuPont, USA) and 70% by weight of an ethylene/vinyl acetate copolymer containing 18 mol % of vinyl acetate units (Elvax 3165® LG supplied by DuPont, USA), the layer having a thickness of 9 μm;

a gas barrier layer b) consisting of a copolymer of vinylidene chloride and maleic acid (Ixan® PVS 815 supplied by Solvin, Belgium), which layer has a thickness of 6 μm and is located between the two adhesion promoter layers;

an adhesion promoter layer consisting of a mixture of 30% by weight of an ethylene/vinyl acetate copolymer containing 12 mol % of vinyl acetate units (Elvax® 3135X supplied by DuPont) and 70% by weight of an ethylene/vinyl acetate copolymer containing 18 mol % of vinyl acetate units (Elvax 3165® LG), this layer having a thickness of 15 μm;

a sealing layer c) attached thereto and consisting of a mixture of 73% by weight of a copolymer of ethylene and an alpha-olefin (Affinity PF 1140G supplied by Dow Plastics, USA); 24% by weight of LLDPE (Stamylex® 08026-F supplied by DexPlastomers, Netherlands), and 3% by weight of an anti-blocking agent (Polybatch FSU 105E supplied by A. Schulman, Inc., USA), this layer having a thickness of 14 μm.

A lacquer based on an ethylene/vinyl chloride copolymer was applied to both sides of the flat multilayered film tube by means of print/anilox roll application. The excess lacquer was wiped off with a doctor blade. 1 g of lacquer per m² of free surface area of the outer layer of the flat film tube was applied to both outer sides of the tube. The multilayered film tube lacquered in this way was subsequently dried in a drying channel at a temperature of 30° C..

Measurement of the shrinkability of the oriented multilayered films coated in this way with lacquer was carried out according to the method mentioned above and the results were in each case as follows:

cmd: 40%

md: 32%

The adhesive strength of the film according to the invention as determined by the method described above, was 0.7 N/15 mm.

The multilayered film was processed in a packaging machine to form sachets. The rejects were not more than 2% of sachets which had overlapped during the sealing process.

### COMPARATIVE EXAMPLE

A multilayered film having the same construction as described under Example 1 was produced by the coextrusion/blowing process.

No lacquer was applied to the free tube surfaces of the flat multilayered film tube.

The multilayered film was processed to produce sachets on a packaging machine. The rejects were 95% of sachets which had overlapped during sealing.

1. A shrinkable multilayered film comprising at least the following layers: a) a carrier layer based on at least one thermoplastic polymer, b) a gas barrier layer, and c) a sealing layer, wherein that surface of said carrier layer a) which is remote from the gas barrier layer b) is entirely covered with an outer release layer d) which has a plasticizing or melting temperature which exceeds the sealing or melting temperature of said sealing layer c) by at least 30° C..

2. The multilayered film of claim 1, wherein said release layer d) has a plasticizing or melting temperature which exceeds the sealing or melting temperature of said sealing layer c) by at least 60° C..

3. The multilayered film of claim 1, wherein the thermoplastic polymer of the carrier layer a) has a melting temperature of not more than 170° C., preferably less than 160° C.

4. The multilayered film of claim 1, wherein the carrier layer a) is based on at least one thermoplastic polymer selected from the group consisting of polyamides, copolyamides, polyolefins, and olefin-copolymers.

5. The multilayered film as defined in claim 4, wherein the carrier layer a) is based on an aliphatic polyamide or copolyamide, on a polyethylene, a polypropylene, an ethylene copolymer, and/or a propylene copolymer.

6. The multilayered film of claim 1, wherein the gas barrier layer b) is based on at least one polymer selected from the group consisting of ethylene/vinyl alcohol copolymers, vinylidene chloride copolymers, polyesters and polyamides.

7. The multilayered film of claim 1, wherein the sealing layer c) is based on at least one polymer selected from the group consisting of polyolefins and olefin copolymers.

8. The multilayered film of claim 1, wherein the sealing layer c) is based on a mixture of polyolefins selected from the group consisting of m-polyethylene (m-PE), high-density polyethylene (HDPE), low-density polyethylene (LDPE), linear low-density polyethylene (LLDPE), ethylene copolymer, polypropylene (PP), and propylene copolymer.

9. The multilayered film of claim 7, wherein the sealing layer c) is based on m-PE, LDPE, or a mixture thereof.

10. The multilayered film of claim 1 wherein the sealing layer c) has a sealing or melting temperature of from 90° C. to 140° C.

11. The multilayered film of claims 1, wherein the release layer d) is based on at least one natural or synthetic polymer selected from the group consisting of cellulose derivatives, polysilicones, acrylic resins, epoxy resins, polyesters, ketone resins, hydrocarbon resins, polyamidimides, polyarylamides, polycarbonates, polyether sulfones, polyimides, polyolefins, polyphenylene oxides, polyurethanes, resorcinol resins, vinyl chloride copolymers, silicone resins, urethane alkyd resins, and polyacrylates.

12. The multilayered film of claim 1, wherein the release layer d) has a plasticizing or melting temperature of from 175° C. to 250° C.

13. The multilayered film of claim 1, wherein the release layer d) has a thickness of from 0.1 μm to 10 μm.

14. The multilayered film as defined of claim 1, wherein said multilayered film is oriented in the machine direction at a ratio of from 1:3 to 1:5 and transversely to the machine direction at a ratio of from 1:3 to 1:5.

15. The multilayered film of claim 1, wherein said multilayered film is in the form of blown tubing.

16. A method for packaging goods, which comprises packing said goods in a multilayer film of claim 1.

17. A package formed of a multilayered film of claim 1 for perishable food.

18. A sachet package formed of a blown tubing of claim 15.

19. The multilayered film of claim 8, wherein the sealing layer c) is based on m-PE, LDPE, or a mixture thereof.

20. The method of claim 16, wherein said goods are perishable foodstuffs.
